(19) United States
(12) Patent Application Publication
(10) Pub. No.: US 2026/0036445 A1
(43) Pub. Date: Feb. 5, 2026

(54) REDUNDANT ENCODER WITH OPTICAL DETECTION

(71) Applicant: KABUSHIKI KAISHA YASKAWA DENKI, Kitakyushu-shi (JP)

(72) Inventors: Daisuke FURUKAWA, Fukuoka (JP); Masanao TAKAHASHI, Fukuoka (JP); Yasuhiro MATSUTANI, Fukuoka (JP); Hiroshi TAKADA, Fukuoka (JP)

(21) Appl. No.: 19/097,858

(22) Filed: Apr. 2, 2025

Related U.S. Application Data
(60) Provisional application No. 63/573,475, filed on Apr. 3, 2024.

(30) Foreign Application Priority Data
Jul. 31, 2024 (JP) 2024-125160

(51) Int. Cl. G01D 5/347; G01B 7/30; G01B 11/26; G01D 5/14; G01D 5/16

(52) U.S. Cl. CPC G01D 5/3473; G01B 7/30; G01B 11/26; G01D 5/145; G01D 5/16; G01D 5/34707

(57) ABSTRACT

An encoder includes: an optical first detector configured to detect rotation of a rotation shaft; an optical second detector configured to detect the rotation of the rotation shaft; and circuitry configured to: execute a comparison between a result of detection of the first detector and a result of detection of the second detector; and transmit data including at least the result of detection of the first detector and a result of the comparison.

### CROSS-REFERENCE TO RELATED APPLICATIONS

This application is based upon and claims the benefit of priority from Japanese Patent Application No. 2024-125160, filed on Jul. 31, 2024, and U.S. Provisional Patent Application No. 63/573,475, filed on Apr. 3, 2024, the entire contents of which are incorporated herein by reference.

### BACKGROUND

### Field

The present disclosure relates to an encoder and an encoder system.

### Description of the Related Art

Japanese Patent No. 6428817 discloses a system including an encoder having a first rotation position detection unit that is optical and a second rotation position detection unit that is magnetic, and a motor control device configured to compare a rotation position detected by the first rotation position detection unit with a rotation position detected by the second rotation position detection unit.

### SUMMARY

Disclosed herein is an encoder. The encoder may include: an optical first detector configured to detect rotation of a rotation shaft; an optical second detector configured to detect the rotation of the rotation shaft; and circuitry configured to: execute a comparison between a result of detection of the first detector and a result of detection of the second detector; and transmit data including at least the result of detection of the first detector and a result of the comparison.

### BRIEF DESCRIPTION OF THE DRAWINGS

FIG. 1 is a schematic diagram illustrating an example configuration of a servo system.

FIG. 2 is a schematic diagram illustrating an example of multiple code tracks.

FIG. 3 is a schematic diagram illustrating an example layout of multiple optical sensors.

FIG. 4 is a block diagram illustrating an example functional configuration of a circuit board.

FIG. 5 is a diagram illustrating an example configuration of protocol data units.

FIG. 6 is a block diagram illustrating a modification of the circuit board.

FIG. 7 is a block diagram illustrating another modification of the circuit board.

FIG. 8 is a block diagram illustrating yet another modification of the circuit board.

FIG. 9 is a block diagram illustrating a modification of a servo system.

FIG. 10 is a block diagram illustrating an example hardware configuration of the circuit board and the expansion unit.

FIG. 11 is a flowchart illustrating an example startup procedure of an encoder.

FIG. 12 is a flowchart illustrating an example data transmission procedure by an encoder.

FIG. 13 is a flowchart illustrating an example generation procedure of the first protocol data unit.

FIG. 14 is a flowchart illustrating an example generation procedure of the second protocol data unit.

FIG. 15 is a flowchart illustrating an example first monitoring procedure by the expansion unit.

FIG. 16 is a flowchart illustrating an example second monitoring procedure by the expansion unit.

### DETAILED DESCRIPTION

In the following description, with reference to the drawings, the same reference numbers are assigned to the same components or to similar components having the same function, and overlapping description is omitted.

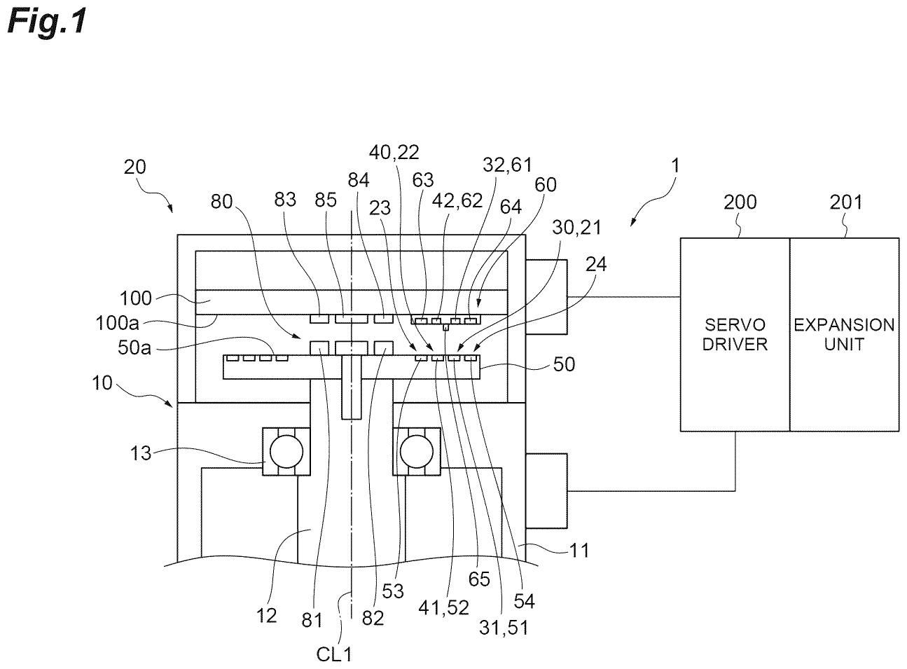

FIG. 1 illustrates a system that performs feedback control of the position or speed of a motor 10 and the system includes the motor 10, an encoder 20, and a servo driver 200. The motor 10 includes a rotation shaft 12, a frame 11, and a bearing 13. The rotation shaft 12 has a central axis CL1 and extends along the central axis CL1. The frame 11 accommodates the rotation shaft 12. The bearing 13 is fixed to the frame 11 and holds an end of the rotation shaft 12 so as to be rotatable around the central axis CL1. The end of the rotation shaft 12 protrudes outside the frame 11 through the bearing 13. The motor 10 rotates the rotation shaft 12 around the central axis CL1 upon receiving power supply.

The encoder 20 is attached to the frame 11 and detects the rotation of the rotation shaft 12. The encoder 20 can communicate with the servo driver 200 via, for example, serial communication. The servo driver 200 performs feedback control of the position of the motor 10 (for example, the rotation angle of the rotation shaft 12) or the speed of the motor 10 (for example, the rotational speed of the rotation shaft 12). For example, the servo driver 200 acquires the detection result of the rotation of the rotation shaft 12 from the encoder 20 and supplies power to the motor 10 to bring the rotation angle or rotational speed of the rotation shaft 12 closer to a target value.

To perform feedback control with reliability is related to a reliability of the detection result (result of detection) by the encoder 20. Accordingly, the encoder 20 includes a first detector 30, a second detector 40, and a circuit board 100. Each of the first detector 30 and the second detector 40 detects the rotation of the rotation shaft 12. Both the first detector 30 and the second detector 40 are optical. Each of the first detector 30 and the second detector 40 may be configured to directly detect the rotation of the rotation shaft 12.

The circuit board 100 is configured to execute: executing a comparison between the detection result of the first detector 30 and the detection result of the second detector 40; and transmitting data including at least the detection result of the first detector 30 and a comparison result (a result of the comparison between the detection result of the first detector 30 and the detection result of the second detector 40).

According to the circuit board 100, in addition to the detection result of the first detector 30, the comparison result between the detection result of the first detector 30 and the detection result of the second detector 40 is transmitted. Accordingly, for example, the servo driver 200 can receive data including the detection result of the first detector 30 and the comparison result, and evaluate the reliability of the detection result by the encoder 20 based on the comparison result. For example, if the detection result of the first detector 30 matches the detection result of the second detector 40, it can be judged that the reliability of the detection result by the encoder 20 is maintained. On the other hand, if the detection result of the first detector 30 does not match the detection result of the second detector 40, it can be judged that the reliability of the detection result by the encoder 20 has decreased.

The resolution of rotational detection by optical methods tends to be finer compared to magnetic methods or the like. In the encoder 20, since both the first detector 30 and the second detector 40 are optical, the resolution of the comparison result between the detection result from the first detector 30 (result of detection of the first detector 30) and the detection result of the second detector 40 (result of detection of the second detector 40) is also fine. For example, whether the detection result of the first detector 30 matches the detection result of the second detector 40 may be determined with fine resolution. This allows for detecting a decrease in reliability with sensitivity. Accordingly, it is beneficial for improving reliability.

The first detector 30 may include a first code track 31 and a first optical sensor 32. The first code track 31 is fixed to the rotation shaft 12 to rotate together with the rotation shaft 12. The first optical sensor 32 outputs a signal corresponding to the rotation of the first code track 31 based on light that has passed through the first code track 31. The light that has passed through the first code track 31 may be light reflected by the first code track 31 or light transmitted through the first code track 31. The first optical sensor 32 may be an optical sensor array including a set of optical sensors arranged along the circumferential direction around the rotation shaft 12.

The second detector 40 may include a second code track 41 and a second optical sensor 42. The second code track 41 is fixed to the rotation shaft 12 to rotate together with the rotation shaft 12. The second optical sensor 42 outputs a signal corresponding to the rotation of the second code track 41 based on light that has passed through the second code track 41. Similar to the light that has passed through the first code track 31, the light that has passed through the second code track 41 may be light reflected by the second code track 41 or light transmitted through the second code track 41. The second optical sensor 42 may be an optical sensor array including a set of optical sensors arranged along the circumferential direction around the rotation shaft 12.

In this way, by individually providing combinations of code tracks and optical sensors to each of the first detector 30 and the second detector 40, reliability can be further improved. The code tracks have multiple codes and multiple spaces alternately arranged along the circumferential direction around the rotation shaft 12. Each of the multiple codes sends light to the optical sensors by transmission or reflection. For example, each of the multiple codes reflects light toward the optical sensors.

The first code track 31 and the second code track 41 may be arranged in the radial direction perpendicular to the rotation shaft 12. The first optical sensor 32 and the second optical sensor 42 may be arranged in the radial direction corresponding to the first code track 31 and the second code track 41, respectively. By bringing the first code track 31 and the second code track 41 close to each other, the sharing of the light source can be facilitated.

The first detector 30 and the second detector 40 may share a single light source 65. The first optical sensor 32 may output a signal corresponding to the rotation of the first code track 31 based on light emitted from the light source 65 and passing through the first code track 31. The second optical sensor 42 may output a signal corresponding to the rotation of the second code track 41 based on light emitted from the light source 65 and passing through the second code track 41. By sharing the light source 65, the size of the encoder 20 can be reduced.

The resolution of the second detector 40 may be lower than the resolution of the first detector 30. By intentionally lowering the resolution of the second detector 40 used for comparison, a balance between reliability and cost can be achieved. The resolution is the minimum detectable angle and is determined by the number of multiple codes and multiple spaces included in one rotation.

The first optical sensor 32 and the second optical sensor 42 may be included in a single optical module 60. The light source 65 may be provided between the first optical sensor 32 and the second optical sensor 42 in the optical module 60. By mounting the light source 65 together with the first optical sensor 32 and the second optical sensor 42 within the single optical module 60, further miniaturization can be achieved.

The first code track 31 and the second code track 41 may be fixed to the rotation shaft 12 via another element that is fixed to the rotation shaft 12. For example, the first code track 31 and the second code track 41 may be formed on the same surface of a single disk 50 that is fixed to the rotation shaft 12 to rotate together with the rotation shaft 12. By sharing the disk 50, further miniaturization can be achieved. For example, the disk 50 is fixed to the end of the rotation shaft 12 by bolting or the like and extends outward from the outer circumference of the rotation shaft 12 throughout the entire circumference. The disk 50 has a code surface 50a facing away from the motor 10. Each of the first code track 31 and the second code track 41 is formed on the code surface 50a so as to surround the rotation shaft 12.

The encoder 20 may be an absolute-type encoder that detects the absolute rotation angle of the rotation shaft 12 relative to the frame 11. Each of the first detector 30 and the second detector 40 may be one of multiple sub detectors used to detect the absolute rotation angle. For example, the encoder 20 includes the multiple sub detection units 21, 22, 23, and 24, and detects the absolute rotation angle of the rotation shaft 12 by combining the detection results from the multiple sub detection units 21, 22, 23, and 24.

The sub detector 21 includes an optical sensor array 61 and a code track 51. The sub detector 22 includes an optical sensor array 62 and a code track 52. The sub detector 23 includes an optical sensor array 63 and a code track 53. The sub detector 24 includes an optical sensor array 64 and a code track 54. For example, the sub detector 21 is used as the aforementioned first detector 30, and the sub detector 22 is used as the aforementioned second detector 40. The optical sensor arrays 61, 62, 63, and 64 are included in the optical module 60. The code tracks 51, 52, 53, and 54 are formed on the code surface 50a.

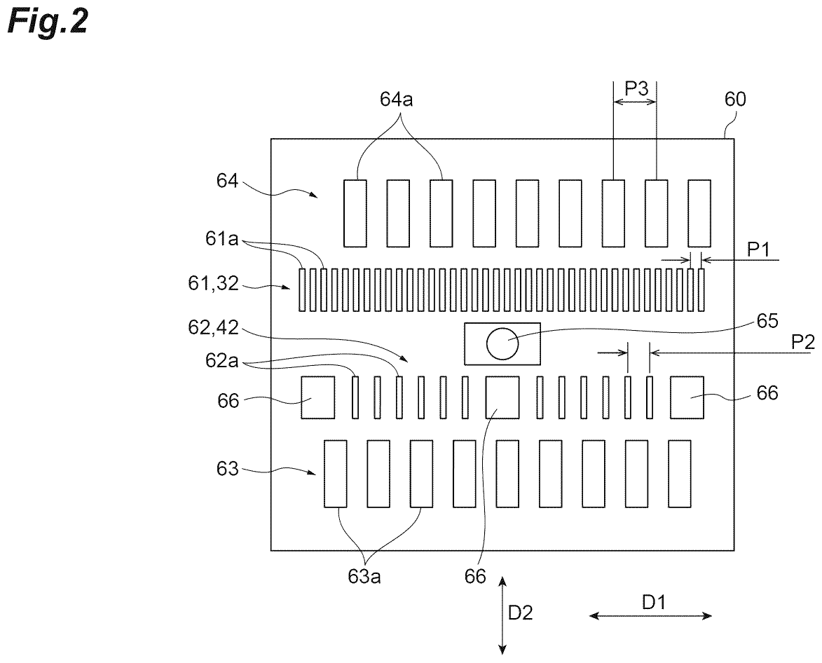

As illustrated in FIG. 2, the optical sensor array 61 has multiple optical sensors 61a arranged along a circumferential direction D1 around the rotation shaft 12. For example, the multiple optical sensors 61a are arranged at a fixed pitch P1. The optical sensor array 61 is used as the first optical sensor 32.

The optical sensor array 62 has multiple optical sensors 62a arranged along circumferential direction D1. For example, the multiple optical sensors 62a are arranged at a fixed pitch P2. The pitch P2 may be larger than the pitch P1. For example, the pitch P2 is twice the pitch P1. The optical sensor array 62 is used as the second optical sensor 42.

The optical sensor array 63 has multiple optical sensors 63a arranged along circumferential direction D1. For example, the multiple optical sensors 63a are arranged at a fixed pitch P3. The pitch P3 may be larger than the pitch P2. The optical sensor array 64 has multiple optical sensors 64a arranged along circumferential direction D1. For example, the multiple optical sensors 64a are arranged at the pitch P3. The positions of the optical sensor array 63 and the optical sensor array 64 in the circumferential direction D1 may be shifted in phase. For example, the positions of the optical sensor array 63 and the optical sensor array 64 in the circumferential direction D1 may be shifted by an amount smaller than the pitch P3.

The optical sensor arrays 61, 62, 63, and 64 are arranged in order along the radial direction D2 perpendicular to the circumferential direction D1. For example, with reference to the rotation shaft 12, the optical sensor array 62 is located outward of the optical sensor array 63, the optical sensor array 61 is located outward of the optical sensor array 62, and the optical sensor array 64 is located outward of the optical sensor array 61. The optical module 60 may further include one or more optical sensors 66 separate from the optical sensor arrays 61, 62, 63, and 64. The one or more optical sensors 66 are used to evaluate the emission amount of light from the light source 65. For example, the optical module 60 includes three optical sensors 66 arranged at three locations that are aligned, along the circumferential direction D1, with the multiple optical sensors 62a of the optical sensor array 62. Each of the multiple optical sensors 61a, the multiple optical sensors 62a, the multiple optical sensors 63a, the multiple optical sensors 64a, and the one or more optical sensors 66 includes a photoelectric conversion element and generates an electrical signal representing the amount of received light.

The optical module 60 is provided on the circuit board 100. For example, the circuit board 100 is fixed at a position away from the disk 50 on the side away from the motor 10 and has a mounting surface 100a facing the code surface 50a. The optical module 60 is provided on the mounting surface 100a so that the optical sensor arrays 61, 62, 63, 64, the light source 65, and the one or more optical sensors 66 face the code surface 50a.

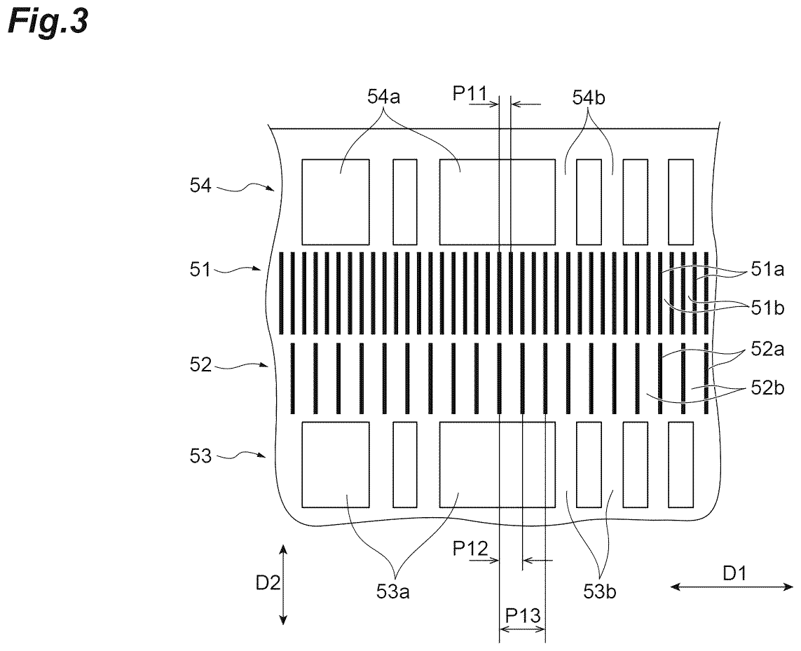

As illustrated in FIG. 3, the code track 51 is formed at a position corresponding to the optical sensor array 61 in the radial direction D2 and used as the first code track 31. The code track 51 has multiple codes 51a and multiple spaces 51b alternately arranged along the circumferential direction D1. For example, the multiple codes 51a are arranged at a fixed pitch P11. The pitch P11 may be the same as the pitch P1 of the multiple optical sensors 61a. Each of the multiple codes 51a reflects light from the light source 65 toward its corresponding optical sensor 61a (one optical sensor 61a of the multiple optical sensors 61a) when located at a position corresponding to the optical sensor 61a. Each of the multiple spaces 51b does not reflect light from the light source 65 toward the optical sensor 61a when located at a position corresponding to the optical sensor 61a. The multiple spaces 51b are, for example, slits. The multiple codes 51a and the multiple spaces 51b pass over the multiple optical sensors 61a due to the rotation of the disk 50. This causes the optical sensor array 61 to generate an electrical signal (for example, a voltage signal) of a sine wave frequency corresponding to the rotational speed of the disk 50.

The code track 52 is formed at a position corresponding to the optical sensor array 62 in the radial direction D2 and used as the second code track 41. The code track 52 has multiple codes 52a and multiple spaces 52b alternately arranged along the circumferential direction D1. For example, the multiple codes 52a are arranged at a fixed pitch P12. The pitch P12 may be the same as the pitch P2 of the multiple optical sensors 62a. For example, the pitch P12 may be twice the pitch P11. Each of the multiple codes 52a reflects light from the light source 65 toward its corresponding optical sensor 62a (one optical sensor 62a of the multiple optical sensors 62a) when located at a position corresponding to the optical sensor 62a. Each of the multiple spaces 52b does not reflect light from the light source 65 toward the optical sensor 61a when located at a position corresponding to the optical sensor 61a. The multiple spaces 52b are, for example, slits. The multiple codes 52a and the multiple spaces 52b pass over the multiple optical sensors 62a due to the rotation of the disk 50. This causes the optical sensor array 62 to generate an electrical signal (for example, a voltage signal) of a sine wave frequency corresponding to the rotational speed of the disk 50.

The code track 53 is formed at a position corresponding to the optical sensor array 63 in the radial direction D2. The code track 53 has multiple codes 53a and multiple spaces 53b alternately arranged along circumferential direction D1. Each of the multiple codes 53a reflects light from the light source 65 toward its corresponding optical sensor 63a (one optical sensor 63a of the multiple optical sensors 63a) when located at a position corresponding to the optical sensor 63a. Each of the multiple spaces 53b does not reflect light from the light source 65 toward the optical sensor 61a when located at a position corresponding to the optical sensor 61a. The multiple spaces 53b are, for example, slits. The multiple codes 53a and the multiple spaces 53b are formed so that the outputs of the multiple optical sensors 63a have unique combinations for each of multiple angular regions obtained by dividing one rotation into a predetermined number. Therefore, based on the combination of outputs from the multiple optical sensors 63a, which angular region is located at the position corresponding to the optical sensor array 63 may be detected. Which of the angular regions is located at the position corresponding to the optical sensor array 63 represents the absolute rotation angle of the rotation shaft 12 at the resolution of the size of the angular region. The size of the angular region (the pitch P13 of the multiple angular regions) is, for example, twice the pitch P12.

The code track 54 is formed in the same manner as the code track 53 at a position corresponding to the optical sensor array 64 in the radial direction D2. The multiple codes 54a and multiple spaces 54b are formed so that the outputs of the multiple optical sensors 64a have unique combinations for each of multiple angular regions obtained by dividing one rotation into a predetermined number. Therefore, based on the combination of outputs from the multiple optical sensors 64a, which angular region is located at the position corresponding to the optical sensor array 64 may be detected. The size of the angular regions provided by the code track 54 is, for example, the same as the size of the angular regions provided by the code track 53.

Returning to FIG. 1, the encoder 20 may further include a third detector 80, and the circuit board 100 may be configured to detect the rotation angle of the rotation shaft 12 based on the detection result of the third detector 80 and the detection result of the first detector 30, and to transmit data further including the detection result of the rotation angle. According to the encoder 20 further including the third detector 80 for detecting the rotation angle, the detection result may be verified by comparing the first detector 30 with the third detector 80. Even in the encoder 20 where the first detector 30 and the third detector 80 can be compared, by verifying the detection result through comparison between the optical first detector 30 and the second detector 40, both acquisition of more information and the resolution of abnormality detection may be achieved.

For example, the circuit board 100 detects the cumulative rotation angle based on the detection result of the cumulative rotation number from the third detector 80 and the detection result of the absolute rotation angle from the first detector 30. The circuit board 100 may be further configured to perform, in addition to the comparison between the first detector 30 and the second detector 40, a comparison between the first detector 30 or the second detector 40 and the third detector 80. For example, when the first detector 30 and the second detector 40 share the single light source 65, if the light source 65 deteriorates, the reliability of both the first detector 30 and the second detector 40 decreases. This decrease in reliability may not be detected by comparison between the first detector 30 and the second detector 40. In contrast, by further performing a comparison between the first detector 30 or the second detector 40 and the third detector 80, the decrease in reliability of both the first detector 30 and the second detector 40 due to the deterioration of the light source 65 may be detected. Therefore, both miniaturization by sharing the light source 65 and reliability may be achieved.

The resolution of the third detector 80 may be lower than both the resolution of the first detector 30 and the resolution of the second detector 40. Since the resolution of abnormality detection is enhanced by the first detector 30 and the second detector 40, the resolution of the third detector 80 can be intentionally lowered to simplify the configuration of the encoder 20.

The third detector 80 may be a magnetic detection unit. For example, the third detector 80 includes a pair of permanent magnets 81 and 82, a pair of Hall sensors 83 and 84, and a magnetoresistive sensor 85. The pair of permanent magnets 81 and 82 are provided on the code surface 50a inward of the code tracks 51, 52, 53, and 54. For example, the pair of permanent magnets 81 and 82 are arranged so that they are point-symmetric with respect to the rotation center of the rotation shaft 12. The pair of permanent magnets 81 and 82 have opposite polarities in the direction perpendicular to the code surface 50a.

The pair of Hall sensors 83 and 84 are provided on the mounting surface 100a so as to correspond to the pair of permanent magnets 81 and 82. The pair of Hall sensors 83 and 84 are arranged so that they are point-symmetric with respect to the rotation center of the rotation shaft 12. Each of the pair of Hall sensors 83 and 84 outputs an electrical signal representing the intensity of the magnetic field from the pair of permanent magnets 81 and 82 due to the Hall effect. As described above, the pair of permanent magnets 81 and 82 have opposite polarities. Accordingly, when the pair of permanent magnets 81 and 82 are respectively opposed to the pair of Hall sensors 83 and 84, the pair of Hall sensors 83 and 84 output electrical signals with opposite signs.

The magnetoresistive sensor 85 is provided on the mounting surface 100a between the pair of Hall sensors 83 and 84 and outputs an electrical signal representing the direction of the magnetic flux from the permanent magnet 81 toward the permanent magnet 82 (or the magnetic flux from the permanent magnet 82 toward the permanent magnet 81). By combining the pair of Hall sensors 83 and 84 and the magnetoresistive sensor 85, the rotation angle of the rotation shaft 12 may be detected with, for example, a resolution of 90°.

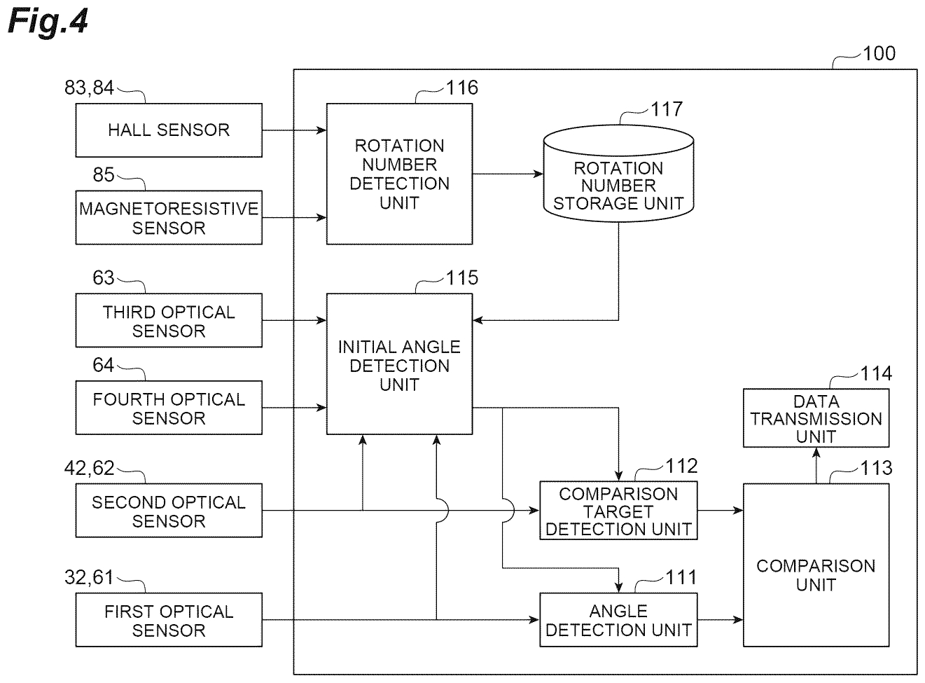

As illustrated in FIG. 4, the circuit board 100 includes an initial angle detector 115, an angle detector 111, a comparison target detector 112, a comparison unit 113, and a data transmission unit 114 as functional components (hereinafter referred to as “functional blocks”). The initial angle detector 115 detects the initial angle of the rotation shaft 12 based on the outputs from the optical sensor arrays 61, 62, 63, and 64 including the first optical sensor 32 and the second optical sensor 42. The initial angle is the absolute rotation angle of the rotation shaft 12 immediately after the startup of the encoder 20. The initial angle detector 115 may detect the initial angle based on a combination of results of detection of one or more other optical sensors included in the optical sensor arrays 61, 62, 63, and 64, the result of detection of the first optical sensor 32, and the result of detection of the second optical sensor 42.

For example, the initial angle detector 115 calculates the absolute rotation angle of the rotation shaft 12 at a resolution of half of the angular region using the combination of the optical sensor arrays 63 and 64 and the optical sensor array 62. Furthermore, the initial angle detector 115 calculates the absolute rotation angle of the rotation shaft 12 at a resolution subdivided further from half of the angular region based on the output values of the optical sensor array 61.

The first detector 30 may detect the first relative rotation angle of the rotation shaft 12 from the initial angle, and the second detector 40 may detect the second relative rotation angle of the rotation shaft 12 from the initial angle.

The angle detector 111 detects the absolute rotation angle of the rotation shaft 12 based on the initial angle calculated by the initial angle detector 115 and the detection result of the first detector 30. For example, the angle detector 111 counts the electrical signals outputted by the first detector 30 (counting up for forward rotation or counting down for reverse rotation), and detects the absolute rotation angle of the rotation shaft 12 by adding the count result to the initial angle. Addition includes adding negative values. The same applies hereinafter. Hereinafter, the absolute rotation angle detected by the angle detector 111 is referred to as the “first absolute rotation angle”. The count result by the angle detector 111 (count result of the electrical signals outputted by the first detector 30) corresponds to the above-mentioned first relative rotation angle detected by the first detector 30.

The comparison target detector 112 detects the absolute rotation angle of the rotation shaft 12 based on the initial angle calculated by the initial angle detector 115 and the detection result of the second detector 40. For example, the comparison target detector 112 counts the electrical signals outputted by the second detector 40 (counting up for forward rotation or counting down for reverse rotation), and detects the absolute rotation angle of the rotation shaft 12 by adding the count result to the initial angle. Hereinafter, the absolute rotation angle detected by the comparison target detector 112 is referred to as the “second absolute rotation angle”. The count result by the comparison target detector 112 (count result of the electrical signals outputted by the second detector 40) corresponds to the above-mentioned second relative rotation angle detected by the second detector 40.

The comparison target detector 112 may repeatedly calculate the second absolute rotation angle based on the outputs of the optical sensor arrays 62, 63, and 64 instead of counting the electrical signals outputted by the second detector 40.

The comparison unit 113 compares the detection result of the first detector 30 with the detection result of the second detector 40. For example, the comparison unit 113 compares the first absolute rotation angle detected by the angle detector 111 with the second absolute rotation angle detected by the comparison target detector 112. As described above, the first absolute rotation angle is determined by the detection result of the first detector 30 (an electrical signal outputted by the first detector 30), and the second absolute rotation angle is determined by the detection result of the second detector 40 (an electrical signal outputted by the second detector 40). Therefore, comparing the first absolute rotation angle with the second absolute rotation angle is an example of comparing the detection result of the first detector 30 with the detection result of the second detector 40.

When the second absolute rotation angle is detected based on the initial angle and the count result by the comparison target detector 112, which is the second relative rotation angle, comparing the first absolute rotation angle with the second absolute rotation angle is also an example of comparing the first relative rotation angle with the second relative rotation angle.

The data transmission unit 114 transmits data including at least the detection result of the first detector 30 and the comparison result (the comparison result between the detection result of the first detector 30 and the detection result of the second detector 40). For example, the data transmission unit 114 transmits data including the first absolute rotation angle as the detection result of the first detector 30 and the comparison result between the first absolute rotation angle and the second absolute rotation angle as the comparison result.

There are no particular limitations on how the comparison result is represented in the data. For example, the data transmission unit 114 may transmit data including an element (for example, a bit) indicating whether the comparison result is OK or NG. Here, “OK” in the comparison result means that there is no difference between the detection result of the first detector 30 and the detection result of the second detector 40, and “NG” in the comparison result means that there is a difference between the detection result of the first detector 30 and the detection result of the second detector 40.

The data transmission unit 114 may repeatedly transmit data including a serial number as an element representing the comparison result. For example, the data transmission unit 114 may transmit data by updating (for example, incrementing by one) the serial number when the comparison result is OK, and transmit data without updating the serial number when the comparison result is NG. Whether the comparison result is OK or NG may be recognized based on whether the serial number included in the data has been updated compared to the previous one.

The data transmission unit 114 may transmit data further including the detection result of the second detector 40. The data recipient can also compare the detection result of the first detector 30 with the detection result of the second detector 40, and verify the reliability of the comparison result of the comparison unit 113. For example, the data transmission unit 114 transmits data further including the second absolute rotation angle as the detection result of the second detector 40.

The circuit board 100 may further include a rotation number detector 116 and a rotation number storage unit 117. The rotation number detector 116 counts the electrical signals outputted by the third detector 80 to detect the cumulative rotation number of rotations of the rotation shaft 12, and causes the rotation number storage unit 117 to store the detection result. The cumulative rotation number is, for example, the cumulative rotation number after the encoder 20 has started detecting the rotation angle of the rotation shaft 12 or after the encoder 20 has been reset. The cumulative rotation number may be represented with the minimum unit being less than one rotation (for example, ¼ rotation) according to the resolution of the third detector 80.

The third detector 80 may continue detecting the rotation of the rotation shaft 12 even during periods when the optical module 60 is stopped. Correspondingly, the rotation number detector 116 may continue detecting the cumulative rotation number even during periods when the optical module 60 is stopped. The rotation number storage unit 117 may retain the detection result even during periods when the optical module 60 is stopped.

The periods when the optical module 60 is stopped are, for example, periods when the power supply to the encoder 20 is stopped. For example, during periods when the optical module 60 is stopped, the third detector 80, the rotation number detector 116, and the rotation number storage unit 117 continue detecting the rotation of the rotation shaft 12, calculating the cumulative rotation number, and retaining the detection result, respectively, by using power supplied from a battery 196.

When the circuit board 100 further includes the rotation number detector 116 and the rotation number storage unit 117, the initial angle detector 115 may detect the initial angle of the rotation shaft 12 based on the detection result of the third detector 80 during the period when the optical module 60 was stopped and the outputs from the optical module 60 after startup. For example, the initial angle detector 115 may detect the cumulative rotation angle of the rotation shaft 12 as the initial angle based on the cumulative rotation number stored in the rotation number storage unit 117 and the absolute rotation angle of the rotation shaft 12 based on the outputs from the optical module 60. For instance, the initial angle detector 115 calculates the cumulative rotation angle by adding the absolute rotation angle to the rotation angle obtained by multiplying the cumulative rotation number by 360°.

When the initial angle detector 115 detects the cumulative rotation angle of the rotation shaft 12 as the initial angle, the angle detector 111 may detect the cumulative rotation angle of the rotation shaft 12 as the above-mentioned first absolute rotation angle based on the initial angle and the detection result of the first detector 30. Since the initial angle is based on the detection result of the third detector 80, the angle detector 111 detects the cumulative rotation angle of the rotation shaft 12 based on the detection result of the third detector 80 and the detection result of the first detector 30.

Similarly, the comparison target detector 112 may detect the cumulative rotation angle of the rotation shaft 12 as the above-mentioned second absolute rotation angle based on the initial angle and the detection result of the second detector 40. Since the initial angle is based on the detection result of the third detector 80, the comparison target detector 112 detects the cumulative rotation angle of the rotation shaft 12 based on the detection result of the third detector 80 and the detection result of the second detector 40.

The data transmission unit 114 may be configured to alternately transmit a first protocol data unit and a second protocol data unit, where the first protocol data unit includes at least the comparison result of the comparison unit 113 and the second protocol data unit includes additional data not included in the first protocol data unit. Alternately transmitting the first protocol data unit and the second protocol data unit includes sequentially transmitting multiple first protocol data units and sequentially transmitting multiple second protocol data units in an alternating fashion.

For example, the first protocol data unit may be a Safety PDU (Protocol Data Unit) whose reliability is backed by the comparison result of the comparison unit 113, and the second protocol data unit may be a Non-Safety PDU whose reliability is not backed by the comparison result of the comparison unit 113.

The first protocol data unit may further include the detection result of the first detector 30, or may further include the detection result of the first detector 30 and the detection result of the second detector 40. The second protocol data unit may include data that are not the subject of comparison by the comparison unit 113. Examples of data not subjected to comparison by the comparison unit 113 include evaluation results of the brightness of the light source 65 based on the outputs from the one or more optical sensors 66, temperature detected inside the encoder 20 or outside the encoder 20, acceleration detected inside the encoder 20 or outside the encoder 20, and the like.

The data transmission unit 114 may be configured to transmit the first protocol data unit or the second protocol data unit repeatedly at fixed cycles. For example, the data transmission unit 114 may transmit the first protocol data unit or the second protocol data unit via serial communication. The data transmission unit 114 may transmit a normal data unit including the detection result of the first detector 30 together with each of the first protocol data unit and the second protocol data unit.

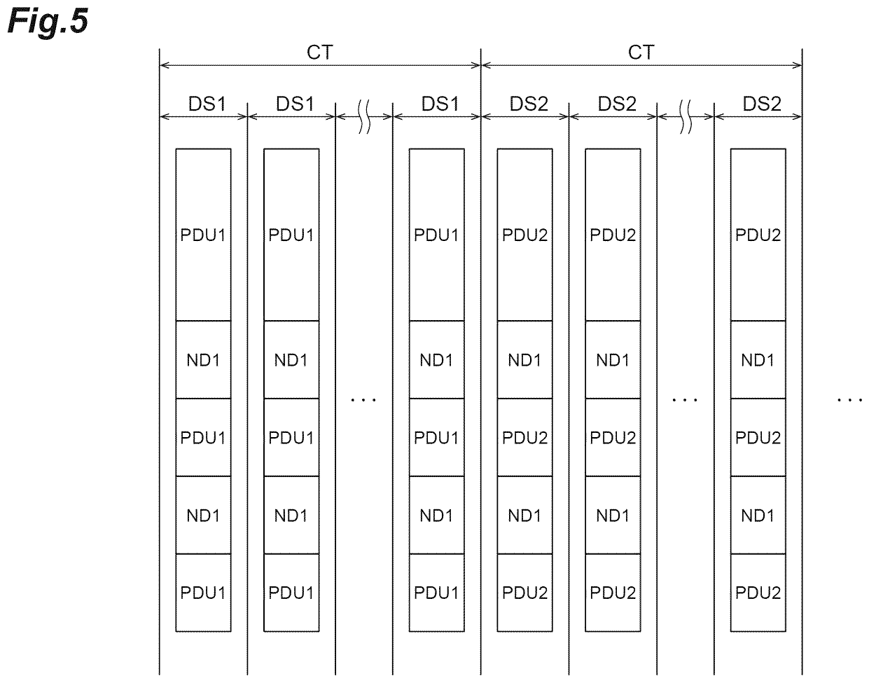

For example, as illustrated in FIG. 5, the data transmission unit 114 transmits to the servo driver 200, at fixed cycles CT, a first data set DS1 including the first protocol data unit PDU1 and the normal data unit ND1, and a second data set DS2 including the second protocol data unit PDU2 and the normal data unit ND1, alternately. For example, the data transmission unit 114 sequentially transmits multiple first data sets DS1 at fixed cycles CT and sequentially transmits multiple second data sets DS2 at fixed cycles CT in an alternating fashion. The servo driver 200 performs feedback control of the position of the motor 10 or speed of the motor 10 based on the normal data unit ND1.

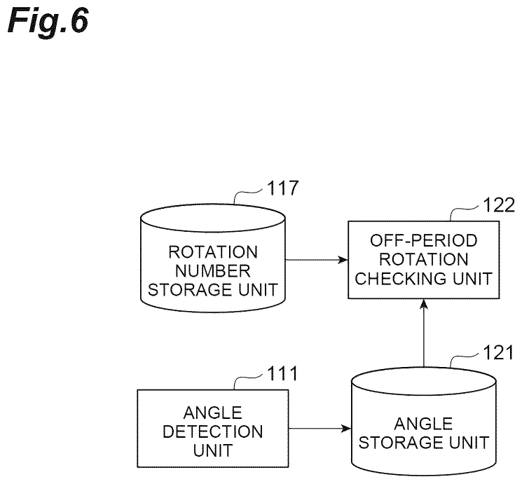

As illustrated in FIG. 6, the circuit board 100 may further include an angle storage unit 121 and an off-period rotation checking unit 122 as functional blocks. The angle storage unit 121 stores the cumulative rotation angle detected by the angle detector 111. As described above, the cumulative rotation number stored in the rotation number storage unit 117 is continuously updated even during periods when the optical module 60 is stopped. In contrast, the cumulative rotation angle stored in the angle storage unit 121 is not updated during periods when the optical module 60 is stopped.

The off-period rotation checking unit 122 checks whether the number of rotations of the rotation shaft 12 during the period when the optical module 60 was stopped (hereinafter referred to as “off-period rotation number”) is equal to or exceeds a predetermined number of times (for example, one rotation) based on the cumulative rotation number stored in the rotation number storage unit 117 and the cumulative rotation angle stored in the angle storage unit 121. The data transmission unit 114 may transmit data further including the confirmation result by the off-period rotation checking unit 122. For example, the data transmission unit 114 may transmit data including an alarm bit indicating whether the off-period rotation number is equal to or exceeds the predetermined number of times.

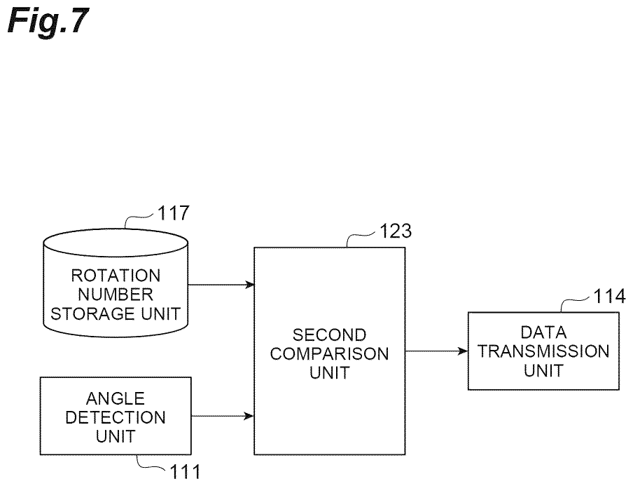

As illustrated in FIG. 7, the circuit board 100 may further include a second comparison unit 123 as a functional block. The second comparison unit 123 compares the detection result of the third detector 80 with the detection result of the first detector 30. For example, the second comparison unit 123 compares the cumulative rotation number stored in the rotation number storage unit 117 with the first absolute rotation angle detected by the angle detector 111. The data transmission unit 114 may transmit data further including the comparison result of the second comparison unit 123. The reliability can be further improved by performing two comparisons including the comparison between the detection result of the first detector 30 and the detection result of the third detector 80 in addition to the comparison between the detection result of the first detector 30 and the detection result of the second detector 40.

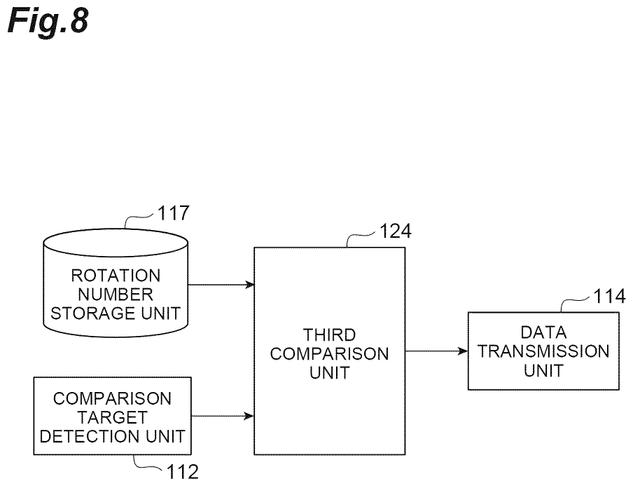

As illustrated in FIG. 8, the circuit board 100 may further include a third comparison unit 124 as a functional block. The third comparison unit 124 compares the detection result of the third detector 80 with the detection result of the second detector 40. For example, the third comparison unit 124 compares the cumulative rotation number stored in the rotation number storage unit 117 with the second absolute rotation angle detected by the comparison target detector 112. The data transmission unit 114 may transmit data further including the comparison result of the third comparison unit 124. The reliability can be further improved by performing three comparisons including the comparison between the detection result of the third detector 80 and the detection result of the second detector 40 in addition to the comparison between the detection result of the first detector 30 and the detection result of the second detector 40 and the comparison between the detection result of the third detector 80 and the detection result of the first detector 30.

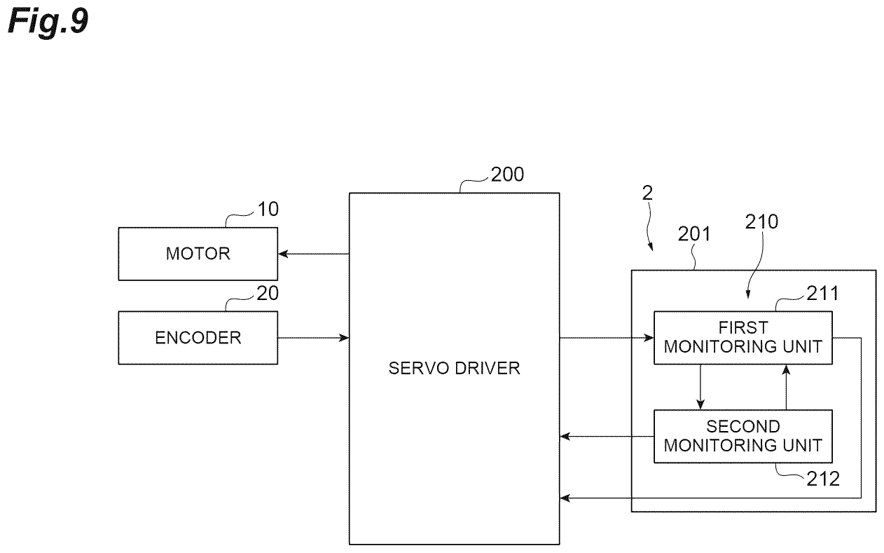

As illustrated in FIG. 9, the servo system 1 may further include an expansion unit 201. The expansion unit 201 is connected to the servo driver 200 and verifies the reliability of the data received by the servo driver 200. For example, the expansion unit 201 receives data from the encoder 20 via serial communication through the servo driver 200. The expansion unit 201 monitors whether the encoder 20 is normal condition based on the received data. The servo system 1 includes an encoder system 2 including the encoder 20 and the expansion unit 201 (an additional circuitry). For example, the expansion unit 201 includes a monitoring unit 210 as a functional block. The monitoring unit 210 receives data from the data transmission unit 114 via the servo driver 200 and monitors whether the data transmission unit 114 is normal condition based on the received data. For example, the monitoring unit 210 may monitor whether the data transmission unit 114 is normal condition based on whether data from the data transmission unit 114 is received at scheduled timings (for example, the above-mentioned fixed cycles). For example, if the monitoring unit 210 can receive data from the data transmission unit 114 at the scheduled timings, the monitoring unit 210 determines that the data transmission unit 114 is normal condition; if the monitoring unit 210 cannot receive data from the data transmission unit 114 at the scheduled timings, the monitoring unit 210 determines that the data transmission unit 114 is abnormal.

In this way, monitoring whether the data transmission unit 114 is normal condition based on the received data includes monitoring whether the data transmission unit 114 is normal condition based on whether there is received data. The monitoring unit 210 may monitor whether the data transmission unit 114 is normal condition based on whether the format of the received data conforms to a predetermined protocol.

The monitoring unit 210 may further monitor whether the comparison unit 113 is normal condition based on the data received from the data transmission unit 114. For example, when the received data includes the detection result of the first detector 30 and the detection result of the second detector 40, the monitoring unit 210 compares the detection result of the first detector 30 with the detection result of the second detector 40 and checks whether the own comparison result of the monitoring unit 210 matches the comparison result included in the received data. If the own comparison result of the monitoring unit 210 matches the comparison result included in the received data, the monitoring unit 210 determines that the comparison unit 113 is normal condition. On the other hand, if the own comparison result of the monitoring unit 210 does not match the comparison result included in the received data, the monitoring unit 210 determines that the comparison unit 113 is abnormal.

The monitoring unit 210 may include a first monitoring unit 211 and a second monitoring unit 212 as functional blocks. Each of the first monitoring unit 211 and the second monitoring unit 212 receives data (a data set) from the data transmission unit 114 and monitors whether the data transmission unit 114 is normal condition based on the received data. Each of the first monitoring unit 211 and the second monitoring unit 212 may further monitor whether the comparison unit 113 is normal condition based on the received data. The second monitoring unit 212 may receive data (a duplicate of the data set) from the data transmission unit 114 via the first monitoring unit 211.

The first monitoring unit 211 may further monitor whether the second monitoring unit 212 is normal condition based on the comparison between the data the first monitoring unit 211 received from the data transmission unit 114 and the data the second monitoring unit 212 received from the data transmission unit 114. For example, the first monitoring unit 211 may determine that the second monitoring unit 212 is normal condition when the data the first monitoring unit 211 received from the data transmission unit 114 matches the data the second monitoring unit 212 received from the data transmission unit 114. Conversely, the first monitoring unit 211 may determine that the second monitoring unit 212 is abnormal when the data the first monitoring unit 211 received from the data transmission unit 114 does not match the data the second monitoring unit 212 received from the data transmission unit 114. That the data the first monitoring unit 211 received from the data transmission unit 114 does not match the data the second monitoring unit 212 received from the data transmission unit 114 includes cases where the second monitoring unit 212 cannot receive the data that the first monitoring unit 211 received.

Similarly, the second monitoring unit 212 may further monitor whether the first monitoring unit 211 is normal condition based on the comparison between the data the second monitoring unit 212 received from the data transmission unit 114 and the data the first monitoring unit 211 received from the data transmission unit 114. For example, the second monitoring unit 212 may determine that the first monitoring unit 211 is normal condition when the data the second monitoring unit 212 received from the data transmission unit 114 matches the data the first monitoring unit 211 received from the data transmission unit 114. Conversely, the second monitoring unit 212 may determine that the first monitoring unit 211 is abnormal when the data the second monitoring unit 212 received from the data transmission unit 114 does not match the data the first monitoring unit 211 received from the data transmission unit 114.

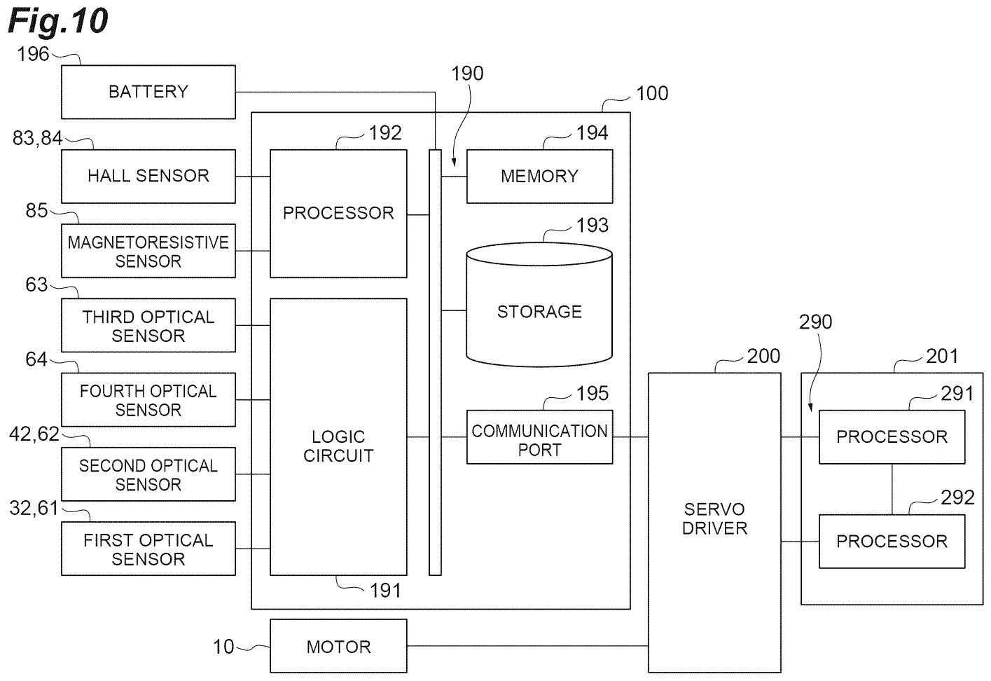

FIG. 10 is a block diagram illustrating the hardware configuration of the circuit board 100 and the expansion unit 201. As illustrated in FIG. 10, the circuit board 100 includes circuitry 190. The circuitry 190 includes a logic circuit 191, a processor 192, storage 193, memory 194, and a communication port 195.

Each of the logic circuit 191 and the processor 192 constitutes one of the above-mentioned functional blocks. For example, the logic circuit 191 is configured by one or more logic devices specialized for specific functions, such as an ASIC (Application Specific Integrated Circuit). The logic circuit 191 constitutes the angle detector 111 and the comparison target detector 112. The processor 192 constitutes the comparison unit 113, the data transmission unit 114, the initial angle detector 115, the rotation number detector 116, the rotation number storage unit 117, the angle storage unit 121, the off-period rotation checking unit 122, the second comparison unit 123, and the third comparison unit 124.

The processor 192 includes one or more computing devices and constitutes one of the functional blocks by executing programs stored in the storage 193. Examples of computing devices include CPUs (Central Processing Units) and the like. The storage 193 includes, for example, one or more non-volatile storage media. The non-volatile storage media include one or more storage devices. Examples of the one or more storage devices include hard disk drives, solid-state drives, flash memory, read-only memory, and the like.

The memory 194 includes one or more volatile storage media and temporarily stores programs loaded from the storage 193. The volatile storage media include one or more memory devices. Examples of the one or more memory devices include random access memory (RAM). The processor 192 constitutes one of the functional blocks by executing programs loaded into the memory 194. The processor 192 may temporarily store calculation results in the memory 194.

The communication port 195 communicates (for example, serial communication) with the servo driver 200 based on requests from the logic circuit 191 or the processor 192. The circuitry 190 may be connected to a battery 196. The battery 196 accumulates power supplied from the circuitry 190 during the operation period of the optical module 60 and supplies power to the circuitry 190 during periods when the optical module 60 is stopped to allow the third detector 80, the rotation number detector 116, and the rotation number storage unit 117 to continue detecting the rotation of the rotation shaft 12, calculating the cumulative rotation number, and retaining the detection result.

The expansion unit 201 includes circuitry 290. The circuitry 290 includes a processor 291 and a processor 292. The processor 291 includes one or more computing devices and constitutes the above-mentioned first monitoring unit 211. The processor 292 includes one or more computing devices and constitutes the above-mentioned second monitoring unit 212. Examples of computing devices include CPUs (Central Processing Units) and the like. Note that although the circuitry 290 is described as having two CPUs (processor 291 and processor 292), it is not limited to this. For example, it may have a multi-core CPU with two or more cores, with each core constituting a monitoring unit (first monitoring unit 211, second monitoring unit 212).

### Rotation Detection Procedure

The following illustrates an example of a rotation detection procedure executed by the encoder 20 and the expansion unit 201 as an example of a rotation detection method. This procedure includes a startup procedure of the encoder 20, a data transmission procedure from the encoder 20 to the servo driver 200, a generation procedure of the first protocol data unit, a generation procedure of the second protocol data unit, a first monitoring procedure, and a second monitoring procedure. Each procedure is illustrated with reference to flowcharts below.

### Startup Procedure

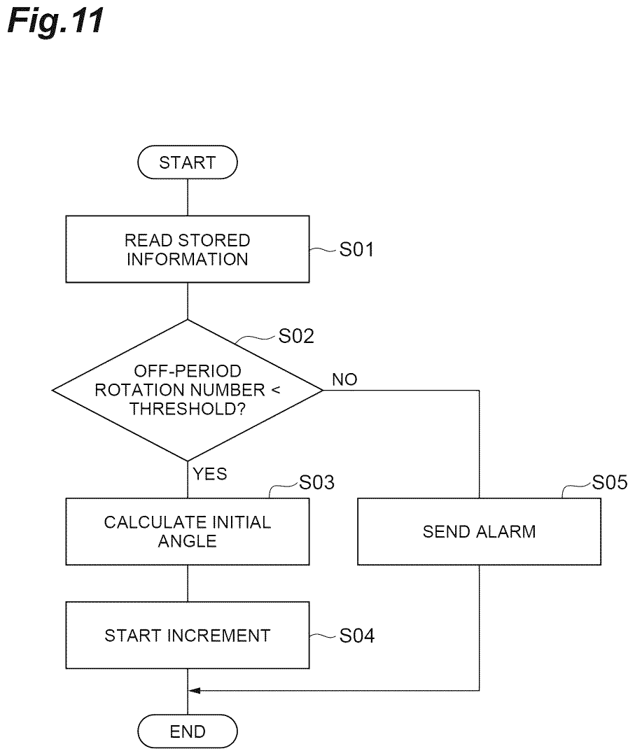

This procedure is executed immediately after the startup of the encoder 20 (before starting rotation angle detection) and is a procedure for checking the rotation number of the rotation shaft 12 during the period when the optical module 60 was stopped. As illustrated in FIG. 11, the circuit board 100 executes operations S01 and S02. In operation S01, the off-period rotation checking unit 122 acquires the cumulative rotation number from the rotation number storage unit 117 and acquires the cumulative rotation angle from the angle storage unit 121. In operation S02, the off-period rotation checking unit 122 checks whether the number of rotations of the rotation shaft 12 during the period when the optical module 60 was stopped (hereinafter referred to as “off-period rotation number”) is below a predetermined threshold value. If it is determined in operation S02 that the number of rotations of the rotation shaft 12 during the period when the optical module 60 was stopped is below the predetermined threshold value, the circuit board 100 executes operations S03 and S04. In operation S03, the initial angle detector 115 detects the initial angle of the rotation shaft 12 based on the outputs from the optical sensor arrays 61, 62, 63, and 64 including the first optical sensor 32 and the second optical sensor 42. In operation S04, the angle detector 111 starts detecting the absolute rotation angle of the rotation shaft 12 based on the initial angle calculated by the initial angle detector 115 and the detection result of the first detector 30. The comparison target detector 112 starts detecting the absolute rotation angle of the rotation shaft 12 based on the initial angle calculated by the initial angle detector 115 and the detection result of the second detector 40. If it is determined in operation S02 that the number of rotations of the rotation shaft 12 during the period when the optical module 60 was stopped is equal to or exceeds the predetermined threshold value, the circuit board 100 executes operation S05. In operation S05, data including an alarm bit indicating that the off-period rotation number is equal to or exceeds the predetermined threshold value is transmitted. This completes the startup procedure.

### Data Transmission Procedure

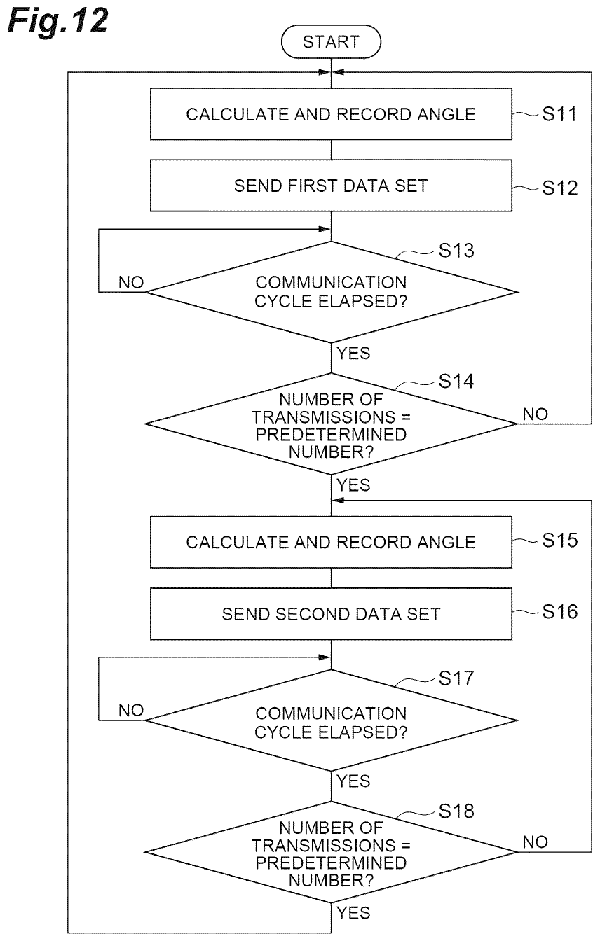

This procedure is a procedure for transmitting data from the encoder 20 to the servo driver 200 and is executed repeatedly at the above-mentioned fixed cycles (hereinafter referred to as “communication cycles”) after the rotation angle detection has started. As illustrated in FIG. 12, the circuit board 100 executes operations S11, S12, S13, and S14. In operation S11, the angle detector 111 detects the first absolute rotation angle, and the comparison target detector 112 detects the second absolute rotation angle. The angle detector 111 stores the first absolute rotation angle in the second comparison unit 123. In operation S12, the data transmission unit 114 generates the first data set DS1 including the first protocol data unit PDU1 and the normal data unit ND1. In operation S13, the data transmission unit 114 waits for the communication cycle to elapse from the start of operation S11. In operation S14, the data transmission unit 114 checks whether the number of transmissions of the first data set DS1 has reached a predetermined number of times.

If it is determined in operation S14 that the number of transmissions has not reached the predetermined number of times, the circuit board 100 returns to operation S11. Thereafter, the transmission of the first data set DS1 is repeated until the number of transmissions reaches the predetermined number of times.

If it is determined in operation S14 that the number of transmissions has reached the predetermined number of times, the circuit board 100 executes operations S15, S16, S17, and S18. In operation S15, the angle detector 111 detects the first absolute rotation angle, and the comparison target detector 112 detects the second absolute rotation angle. The angle detector 111 stores the first absolute rotation angle in the second comparison unit 123. In operation S16, the data transmission unit 114 generates the second data set DS2 including the second protocol data unit PDU2 and the normal data unit ND1. In operation S17, the data transmission unit 114 waits for the communication cycle to elapse from the start of operation S14. In operation S18, the data transmission unit 114 checks whether the number of transmissions of the second data set DS2 has reached the predetermined number of times.

If it is determined in operation S18 that the number of transmissions has not reached the predetermined number of times, the circuit board 100 returns to operation S15. Thereafter, the transmission of the second data set DS2 is repeated until the number of transmissions reaches the predetermined number of times.

If it is determined in operation S18 that the number of transmissions has reached the predetermined number of times, the circuit board 100 returns to operation S11. In this way, transmitting the first data set DS1 repeatedly for the predetermined number of times and transmitting the second data set DS2 repeatedly for the predetermined number of times are alternately repeated.

### Generation Procedure of the First Protocol Data Unit

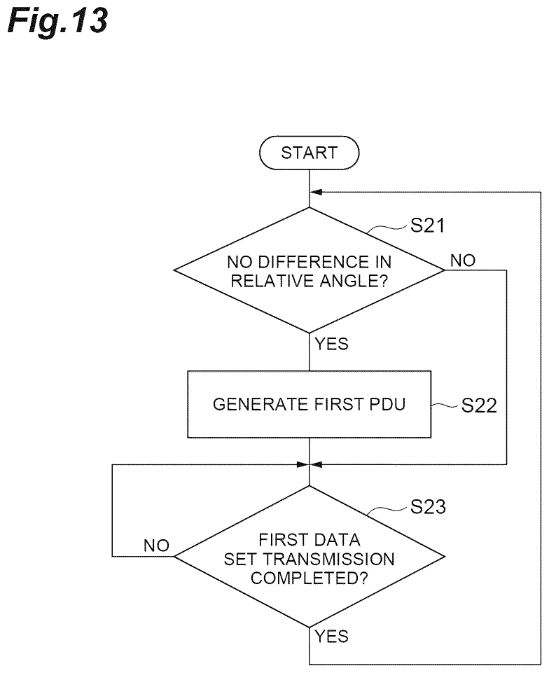

This procedure is a procedure for repeatedly generating the first protocol data unit in accordance with the repetition of data transmission. As illustrated in FIG. 13, the circuit board 100 first executes operation S21. In operation S21, the comparison unit 113 checks whether there is any difference between the first relative rotation angle and the second relative rotation angle. If it is determined in operation S21 that there is no difference between the first relative rotation angle and the second relative rotation angle, the circuit board 100 executes operation S22. In operation S22, the data transmission unit 114 generates the first protocol data unit PDU1.

Next, the circuit board 100 executes operation S23. If it is determined in operation S21 that there is a difference between the first relative rotation angle and the second relative rotation angle, the circuit board 100 proceeds to operation S23 without executing operation S22. In operation S23, the data transmission unit 114 waits for the transmission of the first data set DS1 including the first protocol data unit PDU1 and the normal data unit ND1 (for example, repeating the transmission of the first data set DS1 for the above-mentioned predetermined number of times) to be completed.

Thereafter, the circuit board 100 returns to operation S21. The circuit board 100 repeats the above processing.

### Generation Procedure of the Second Protocol Data Unit

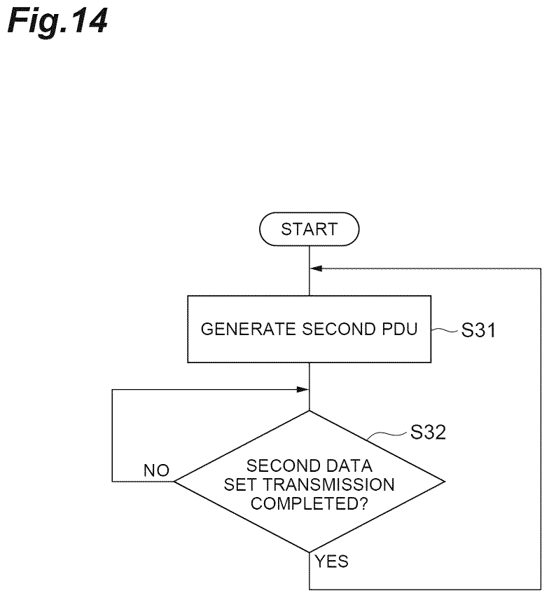

This procedure is a procedure for repeatedly generating the second protocol data unit in accordance with the repetition of data transmission. As illustrated in FIG. 14, the circuit board 100 first executes operation S31. In operation S31, the data transmission unit 114 generates the second protocol data unit PDU2. Next, the circuit board 100 executes operation S32. In operation S32, the data transmission unit 114 waits for the transmission of the second data set DS2 including the second protocol data unit PDU2 and the normal data unit ND1 (for example, repeating the transmission of the second data set DS2 for the above-mentioned predetermined number of times) to be completed.

Thereafter, the circuit board 100 returns to operation S31. The circuit board 100 repeats the above processing.

### First Monitoring Procedure

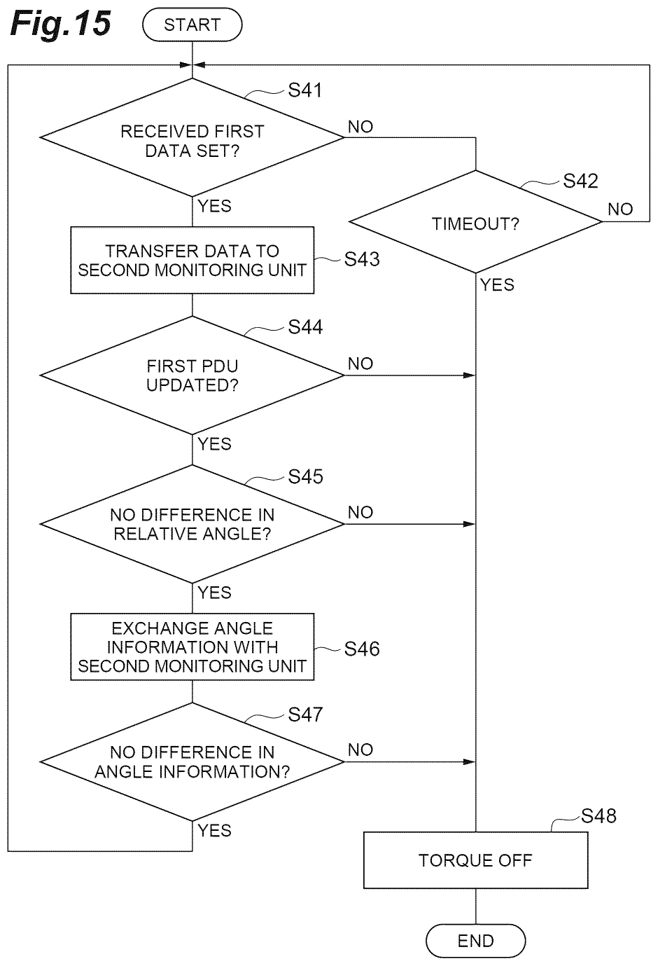

This procedure is a procedure in which the expansion unit 201 repeatedly checks whether the encoder 20 is normal condition in accordance with the repetition of data transmission. As illustrated in FIG. 15, the expansion unit 201 first executes operation S41. In operation S41, the first monitoring unit 211 checks whether it has received the first data set DS1.

If it is determined in operation S41 that the first data set DS1 has not been received, the expansion unit 201 executes operation S42. In operation S42, the first monitoring unit 211 checks whether a predetermined waiting time has timed out. If it is determined in operation S42 that the time has not timed out, the expansion unit 201 returns to operation S41. Thereafter, the expansion unit 201 waits for the first monitoring unit 211 to receive the first data set DS1 or for a timeout to occur.

If it is determined in operation S41 that the first data set DS1 has been received, the expansion unit 201 executes operations S43 and S44. In operation S43, the first monitoring unit 211 transfers the received data to the second monitoring unit 212. In operation S44, the first monitoring unit 211 checks whether the first protocol data unit PDU1 included in the first data set DS1 has been updated.

If it is determined in operation S44 that the first protocol data unit PDU1 has been updated, the expansion unit 201 executes operation S45. In operation S45, the first monitoring unit 211 checks whether there is any difference between the first relative rotation angle and the second relative rotation angle based on the first absolute rotation angle and the second absolute rotation angle included in the first protocol data unit PDU1.

If it is determined in operation S45 that there is no difference between the first relative rotation angle and the second relative rotation angle, the expansion unit 201 executes operations S46 and S47. In operation S46, the first monitoring unit 211 exchanges information regarding the first data set DS1 with the second monitoring unit 212. For example, the first monitoring unit 211 exchanges the confirmation result of whether the first protocol data unit PDU1 has been updated with the second monitoring unit 212. In operation S47, the first monitoring unit 211 checks whether there is any difference between the information the first monitoring unit 211 obtained from the first data set DS1 and the information obtained from the second monitoring unit 212. If it is determined in operation S47 that there is no difference between the information the first monitoring unit 211 obtained from the first data set DS1 and the information obtained from the second monitoring unit 212, the expansion unit 201 returns to operation S41.

If it is determined in operation S42 that a timeout has occurred, if it is determined in operation S44 that the first protocol data unit PDU1 has not been updated, if it is determined in operation S45 that there is a difference, or if it is determined in operation S46 that there is a difference, the expansion unit 201 executes operation S48. In operation S48, the first monitoring unit 211 causes the servo driver 200 to stop generating torque by the motor 10. This completes the first monitoring procedure.

### Second Monitoring Procedure

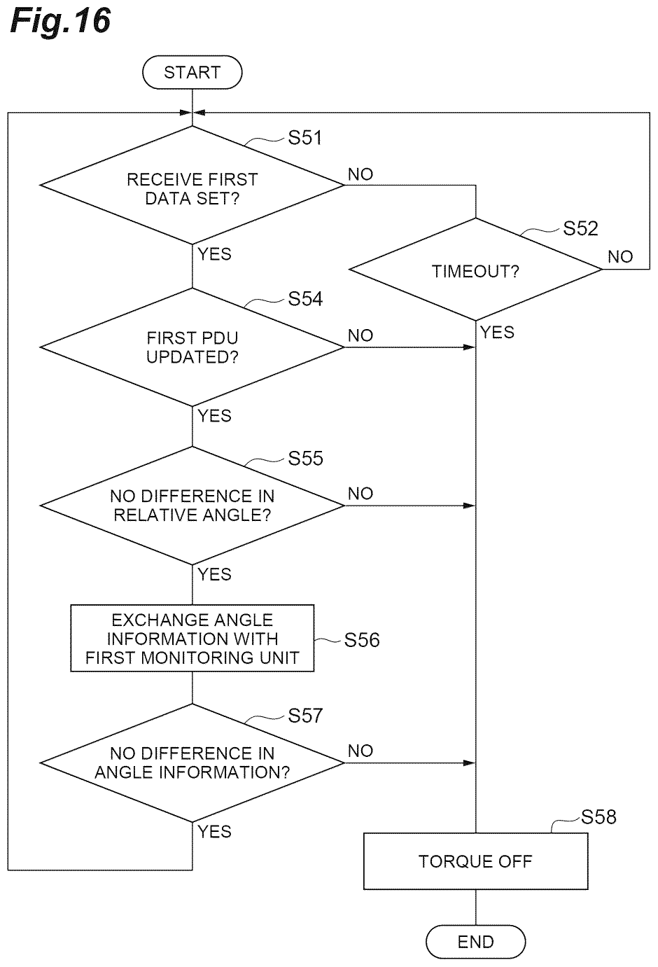

This procedure is a procedure in which the expansion unit 201 repeatedly checks whether the encoder 20 is normal condition in accordance with the repetition of data transmission. As illustrated in FIG. 16, the expansion unit 201 first executes operation S51. In operation S51, the second monitoring unit 212 checks whether it has received the first data set DS1.

If it is determined in operation S51 that the first data set DS1 has not been received, the expansion unit 201 executes operation S52. In operation S52, the second monitoring unit 212 checks whether a predetermined waiting time has timed out. If it is determined in operation S52 that the time has not timed out, the expansion unit 201 returns to operation S51. Thereafter, the expansion unit 201 waits for the second monitoring unit 212 to receive the first data set DS1 or for a timeout to occur.

If it is determined in operation S51 that the first data set DS1 has been received, the expansion unit 201 executes operation S54. In operation S54, the second monitoring unit 212 checks whether the first protocol data unit PDU1 included in the first data set DS1 has been updated.

If it is determined in operation S54 that the first protocol data unit PDU1 has been updated, the expansion unit 201 executes operation S55. In operation S55, the second monitoring unit 212 checks whether there is any difference between the first relative rotation angle and the second relative rotation angle based on the first absolute rotation angle and the second absolute rotation angle included in the first protocol data unit PDU1.

If it is determined in operation S55 that there is no difference between the first relative rotation angle and the second relative rotation angle, the expansion unit 201 executes operations S56 and S57. In operation S56, the second monitoring unit 212 exchanges information regarding the first data set DS1 with the first monitoring unit 211. For example, the second monitoring unit 212 exchanges the confirmation result of whether the first protocol data unit PDU1 has been updated with the first monitoring unit 211. In operation S57, the second monitoring unit 212 checks whether there is any difference between the information the second monitoring unit 212 obtained from the first data set DS1 and the information obtained from the first monitoring unit 211. If it is determined in operation S57 that there is no difference between the information the second monitoring unit 212 obtained from the first data set DS1 and the information obtained from the first monitoring unit 211, the expansion unit 201 returns to operation S51.

If it is determined in operation S52 that a timeout has occurred, if it is determined in operation S54 that the first protocol data unit PDU1 has not been updated, if it is determined in operation S55 that there is a difference, or if it is determined in operation S56 that there is a difference, the expansion unit 201 executes operation S58. In operation S58, the second monitoring unit 212 causes the servo driver 200 to stop generating torque by the motor 10. This completes the second monitoring procedure.

### SUMMARY

The above disclosure includes the following configurations.
(1) An encoder 20 comprising: an optical first detector 30 configured to detect rotation of a rotation shaft; an optical second detector 40 configured to detect rotation of the rotation shaft; a comparison unit 113 configured to compare a detection result of the first detector 30 and a detection result of the second detector 40; and a data transmission unit 114 configured to transmit data including at least the detection result of the first detector 30 and a comparison result of the comparison unit 113. The resolution of rotational detection tends to be finer for optical methods compared to magnetic methods. By verifying the detection result of the rotation angle through comparison between the optical first detector 30 and second detector 40, abnormalities in the detection result may be detected with finer resolution. Therefore, it is beneficial for improving reliability.
(2) The encoder 20 according to (1), further comprising: a third detector 80 configured to detect rotation of the rotation shaft; and an angle detector 111 configured to detect the rotation angle of the rotation shaft based on the detection result of the third detector 80 and the detection result of the first detector 30, wherein the data transmission unit 114 is configured to transmit data further including a detection result of the angle detector 111.

Even in the encoder 20 further comprising the third detector 80 for detecting the rotation angle, by verifying the detection result of the rotation angle through comparison between the optical first detector 30 and the second detector 40, both the acquisition of more information and the resolution of abnormality detection can be achieved.
(3) The encoder 20 according to (2), wherein a resolution of the third detector 80 is lower than both a resolution of the first detector 30 and the resolution of the second detector 40.

Since the resolution of abnormality detection is enhanced by the first detector 30 and the second detector 40, the resolution of the third detector 80 can be intentionally lowered to simplify the configuration.
(4) The encoder 20 according to (2) or (3), further comprising a second comparison unit 123 configured to compare the detection result of the third detector 80 with the detection result of the first detector 30, wherein the data transmission unit 114 is configured to transmit data further including a comparison result of the second comparison unit 123. By performing two comparisons, the reliability can be further improved.
(5) The encoder 20 according to (4), further comprising a third comparison unit 124 configured to compare the detection result of the third detector 80 with the detection result of the second detector 40, wherein the data transmission unit 114 is configured to transmit data further including a comparison result of the third comparison unit 124. By performing three comparisons, the reliability can be further improved.
(6) The encoder 20 according to any one of (1) to (5), wherein the first detector 30 comprises: a first code track 31 that rotates together with the rotation shaft; and a first optical sensor 32 configured to output a signal corresponding to rotation of the first code track 31 based on light that has passed through the first code track 31, and wherein the second detector 40 comprises: a second code track 41 that rotates together with the rotation shaft; and a second optical sensor 42 configured to output a signal corresponding to the rotation of the second code track 41 based on light that has passed through the second code track 41.

By individually providing combinations of code tracks and optical sensors to each of the first detector 30 and the second detector 40, reliability can be further improved.
(7) The encoder 20 according to (6), wherein the first code track 31 and the second code track 41 are arranged in a radial direction perpendicular to the rotation shaft, and wherein the first optical sensor 32 and the second optical sensor 42 are arranged in the radial direction corresponding to the first code track 31 and the second code track 41, respectively.

By bringing the first code track 31 and the second code track 41 close to each other, sharing of the light source 65 can be facilitated.
(8) The encoder 20 according to (6) or (7), wherein a resolution of the second detector 40 is lower than the resolution of the first detector 30.

By intentionally lowering the resolution of the second detector 40 used for comparison, a balance between reliability and cost can be achieved.
(9) The encoder 20 according to any one of (6) to (8), further comprising an initial angle detector 115 configured to detect an initial angle of the rotation shaft based on outputs from a plurality of optical sensors 61, 62, 63, and 64 including the first optical sensor 32 and the second optical sensor 42, wherein the first detector 30 is configured to detect a first relative rotation angle from the initial angle, and wherein the second detector 40 is configured to detect a second relative rotation angle from the initial angle.

By also utilizing two of the multiple optical detection systems for detecting the initial angle as the first detector 30 and the second detector 40, further miniaturization can be achieved.
(10) The encoder 20 according to (9), further comprising a third detector 80 configured to continue detecting rotation of the rotation shaft even during a period when the multiple optical sensors 61, 62, 63, and 64 are stopped, wherein the initial angle detector 115 is configured to detect the initial angle of the rotation shaft based on a detection result of the third detector 80 during the period when the multiple optical sensors 61, 62, 63, and 64 are stopped and the outputs from the multiple optical sensors 61, 62, 63, and 64 after activation.

The third detector 80 can be utilized more beneficially.
(11) The encoder 20 according to any one of (6) to (10), wherein the first detector 30 and the second detector 40 share a single light source 65, wherein the first optical sensor 32 is configured to output a signal corresponding to rotation of the first code track 31 based on light emitted from the light source 65 and passing through the first code track 31, and wherein the second optical sensor 42 is configured to output a signal corresponding to rotation of the second code track 41 based on light emitted from the light source 65 and passing through the second code track 41.

A decrease in reliability of both the first detector 30 and the second detector 40 due to deterioration of the light source 65 can be detected through comparison with the third detector 80. Accordingly, both miniaturization by reducing the number of light sources 65 and reliability can be achieved.
(12) The encoder 20 according to (11), wherein the first optical sensor 32 and the second optical sensor 42 are included in a single optical module 60, and wherein the single light source 65 is provided between the first optical sensor 32 and the second optical sensor 42 in the optical module 60.

By mounting the light source 65 together with the first optical sensor 32 and the second optical sensor 42 within the single optical module 60, further miniaturization can be achieved.
(13) The encoder 20 according to any one of (6) to (12), wherein the first code track 31 and the second code track 41 are formed on an identical surface of a single disk 50 rotating together with the rotation shaft.

By sharing the disk 50, further miniaturization can be achieved.
(14) The encoder 20 according to any one of (1) to (13), wherein the data transmission unit 114 is configured to alternately transmit: a first protocol data unit including the detection result of the first detector 30 and the comparison result of the comparison unit 113; and a second protocol data unit including additional data not included in the first protocol data unit.

Further improvement in reliability can be achieved.
(15) An encoder system 2 comprising: the encoder 20 according to any one of (1) to (14); and a monitoring unit 210 configured to receive data from the data transmission unit 114 and to monitor whether the data transmission unit 114 is normal condition based on the received data. Further improvement in reliability can be achieved.
(16) The encoder system 2 according to (15), wherein the monitoring unit 210 comprises a first monitoring unit 211 and a second monitoring unit 212 each of which is configured to receive data from the data transmission unit 114 and monitor whether the data transmission unit 114 is normal condition based on the received data, wherein the first monitoring unit 211 is configured to further monitor whether the second monitoring unit 212 is normal condition based on a comparison between the data received from the data transmission unit 114 and the data the second monitoring unit 212 has received from the data transmission unit 114, and the second monitoring unit 212 is configured to further monitor whether the first monitoring unit 211 is normal condition based on a comparison between the data received from the data transmission unit 114 and the data the first monitoring unit 211 has received from the data transmission unit 114.

Further improvement in reliability can be achieved.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. An encoder comprising:
an optical first detector configured to detect rotation of a rotation shaft;
an optical second detector configured to detect the rotation of the rotation shaft; and
circuitry configured to:
execute a comparison between a result of detection of the first detector and a result of detection of the second detector; and
transmit data including at least the result of detection of the first detector and a result of the comparison.

2. The encoder according to claim 1, further comprising:
a third detector configured to detect rotation of the rotation shaft, wherein the circuitry is further configured to:
detect a rotation angle of the rotation shaft based on both a result of detection of the third detector and the result of detection of the first detector; and
transmit data further including the detected rotation angle.

3. The encoder according to claim 2, wherein a resolution of the third detector is lower than each of a resolution of the first detector and a resolution of the second detector.

4. The encoder according to claim 3, wherein the third detector is a magnetic detector.

5. The encoder according to claim 2, wherein the circuitry is further configured to:
execute a second comparison between the result of detection of the third detector and the result of detection of the first detector; and
transmit data further including a result of the second comparison.

6. The encoder according to claim 5, wherein the circuitry is further configured to:
execute a third comparison between the result of detection of the third detector and the result of detection of the second detector; and
transmit data further including a result of the third comparison.

7. The encoder according to claim 1, wherein each of the first detector and the second detector is configured to directly detect the rotation of the rotation shaft.

8. The encoder according to claim 1, wherein the first detector comprises:
a first code track fixed to the rotation shaft; and
a first optical sensor configured to output a signal corresponding to rotation of the first code track based on light that has been transmitted via the first code track, and
wherein the second detector comprises:
a second code track fixed to the rotation shaft; and
a second optical sensor configured to output a signal corresponding to rotation of the second code track based on light that has been transmitted via the second code track.

9. The encoder according to claim 8, wherein the first code track and the second code track are arranged along a radial direction perpendicular to the rotation shaft; and
wherein the first optical sensor and the second optical sensor are arranged along the radial direction corresponding to the first code track and the second code track, respectively.

10. The encoder according to claim 8, wherein a resolution of the second detector is lower than a resolution of the first detector.

11. The encoder according to claim 8, wherein the circuitry is further configured to detect an initial angle of the rotation shaft based on outputs from a plurality of optical sensors including the first optical sensor and the second optical sensor,
wherein the first detector is configured to detect a first relative rotation angle from the initial angle, and
wherein the second detector is configured to detect a second relative rotation angle from the initial angle.

12. The encoder according to claim 11, wherein the plurality of optical sensors further includes one or more other optical sensors together with the first optical sensor and the second optical sensor, and
wherein the circuitry is configured to detect the initial angle of the rotation shaft based on a combination of the outputs from the one or more other optical sensors, the first optical sensor, and the second optical sensor.

13. The encoder according to claim 12, wherein the circuitry is configured to:
detect an absolute first angle at a first resolution based on a combination of outputs from the one or more other optical sensors and the second optical sensor; and
detect, as the initial angle, an absolute second angle at a second resolution subdivided further from the first resolution based on an output from the first optical sensor and the absolute first angle.

14. The encoder according to claim 11, further comprising a third detector configured to continue detecting rotation of the rotation shaft even before activation of the plurality of optical sensors,
wherein the circuitry is configured to detect the initial angle of the rotation shaft based on a detection result of the third detector acquired before the activation and the outputs of the plurality of optical sensors acquired after the activation.

15. The encoder according to claim 8, wherein the first detector and the second detector share a single light source,
wherein the first optical sensor is configured to output a signal corresponding to rotation of the first code track based on light emitted from the light source and transmitted via the first code track, and
wherein the second optical sensor is configured to output a signal corresponding to rotation of the second code track based on light emitted from the light source and transmitted via the second code track.

16. The encoder according to claim 15, wherein the first optical sensor and the second optical sensor are included in a single optical assembly, and
wherein the single light source is provided between the first optical sensor and the second optical sensor in the optical assembly.

17. The encoder according to claim 8, wherein the first code track and the second code track are formed on an identical surface of a single disk fixed to the rotation shaft.

18. The encoder according to claim 1, wherein the circuitry is configured to alternately transmit:
a first protocol data unit including the result of detection of the first detector and the result of the comparison; and
a second protocol data unit including additional data not included in the first protocol data unit.

19. An encoder system comprising:
the encoder according to claim 1; and
additional circuitry configured to:
receive data from the circuitry; and
monitor whether the circuitry is in normal condition based on the result of the comparison included in the received data.

20. The encoder system according to claim 19, wherein the additional circuitry is configured to:
receive a data set from the circuitry and monitor whether the circuitry is in normal condition based on the result of the comparison included in the data set;
receive a duplicate of the data set from the circuitry;
execute an additional comparison between the data set and the duplicate of the data set; and
monitor whether the additional circuitry is in normal condition based on a result of the additional comparison.
